(19) United States
(12) Patent Application Publication
(10) Pub. No.: US 2023/0237351 A1
(43) Pub. Date: Jul. 27, 2023

(54) INFERENCE APPARATUS, INFERENCE METHOD, AND COMPUTER-READABLE RECORDING MEDIUM

(71) Applicant: NEC Corporation, Minato-ku, Tokyo (JP)

(72) Inventor: Daichi KIMURA, Tokyo (JP)

(73) Assignee: NEC Corporation, Minato-ku, Tokyo (JP)

(21) Appl. No.: 18/010,478

(22) PCT Filed: Jun. 17, 2020
(86) PCT No.: PCT/JP2020/023768

§ 371 Date: Dec. 15, 2022

(51) Int. Cl. G06N 5/04

(52) U.S. Cl. CPC G06N 5/041

(57) ABSTRACT

An inference apparatus includes: an abduction unit that executes abduction by applying inference knowledge including a plurality of rules that are represented by logical formulas to an observation logical formula obtained by representing an observed fact using a logical formula, and outputting a plurality of solution hypotheses whose costs are the same; and a selection unit that selects, by evaluating each of the solution hypotheses based on an evaluation criterion, a solution hypothesis according to evaluation results.

### TECHNICAL FIELD

The invention relates to an inference apparatus and an inference method for performing inference for deriving a hypothesis with respect to observed events, and further relates to a computer-readable recording medium having recorded thereon a program for realizing the apparatus and method.

### BACKGROUND ART

In the cyber security, when a certain event is observed in a system of an organization, for example, whether the observed event has been caused by a cyber-attack needs to be determined. A method of applying abduction is promising as a method for realizing such determination.

Abduction is inference for deriving a best hypothesis with respect to observed events using inference knowledge (plurality of rules) given by logical formulas and an event that has been observed (observed event). A case where abduction is applied to the above-described determination as to whether or not a cyber-attack has been executed on a system will be described as an example. Whether or not there was a cyber-attack is determined by deriving a hypothesis using rules prepared in advance for the system and the observed event.

Moreover, abduction includes weighted abduction disclosed in Non-Patent Document 1 for specifying a best hypothesis from a plurality of hypothesis candidates. In the weighted abduction, weights are assigned to rules, and costs are assigned to observed events. Next, in the weighted abduction, hypothesis candidates are generated by performing a backward reasoning operation with respect to the weighted rules and the observed events with cost. Also, in the weighted abduction, a cost is calculated for each hypothesis candidate by performing a unification operation, and a hypothesis is specified from the generated hypothesis candidates based on the calculated costs. Note that, with respect to the hypothesis candidates, the costs indicate that the smaller the cost is, the hypothesis is better. The hypothesis candidate with a minimum cost is also referred to as a solution hypothesis.

### LIST OF RELATED ART DOCUMENTS

### Non-Patent Document

Non-Patent Document 1: J. R. Hobbs, M. Stickel, P. Martin, and D. Edwards, “Interpretation as abduction”, Artificial Intelligence, Vol. 63, pp. 69-142, 1993.

### SUMMARY

### Technical Problems

However, logical formulas are used in abduction, and therefore a numerical relationship cannot be handled. For example, numerical relationships are desired to be reflected on abduction in cases such as a case where, when a plurality of evidences (observed events) are obtained, it is desired that the closer the times at which evidences are obtained, the evidences are regarded to be more related to each other, and in a case where, when evidences of the same type are obtained, it is desired to adopt an evidence that is observed earlier. However, the numerical relationship is difficult to be represented by a logical formula.

An example object of the invention, as one aspect, is to provide an inference apparatus, an inference method and a computer-readable recording medium, with which a numerical relationship can be reflected on abduction.

### Solution to the Problems

In order to achieve the example object described above, an inference apparatus according to an example aspect includes:
an abduction unit that executes abduction by applying inference knowledge including a plurality of rules that are represented by logical formulas to an observation logical formula obtained by representing an observed fact using a logical formula, and outputting a plurality of solution hypotheses whose costs are the same; and
a selection unit that selects, by evaluating each of the solution hypotheses based on an evaluation criterion, a solution hypothesis according to evaluation results.

Also, in order to achieve the example object described above, an inference method according to an example aspect includes:
an abduction step of executing abduction by applying inference knowledge including a plurality of rules that are represented by logical formulas to an observation logical formula obtained by representing an observed fact using a logical formula, and outputting a plurality of solution hypotheses whose costs are the same; and
a selection step of selecting, by evaluating each of the solution hypotheses based on an evaluation criterion, a solution hypothesis based on evaluation results.

Furthermore, in order to achieve the example object described above, a computer-readable recording medium according to an example aspect includes a program recorded on the computer-readable recording medium, the program including instructions that cause the computer to carry out:
an abduction step of executing abduction by applying inference knowledge including a plurality of rules that are represented by logical formulas to an observation logical formula obtained by representing an observed fact using a logical formula, and outputting a plurality of solution hypotheses whose costs are the same; and
a selection step of selecting, by evaluating each of the solution hypotheses based on an evaluation criterion, a solution hypothesis based on evaluation results.

### ADVANTAGEOUS EFFECTS OF THE INVENTION

As one aspect, it is possible to reflect numerical relationships on abduction.

### BRIEF DESCRIPTION OF THE DRAWINGS

FIG. 1 is a diagram for describing weighted abduction and a numerical relationship.

FIG. 2 is a diagram for describing weighted abduction and a numerical relationship.

FIG. 3 is a diagram for describing an example of the inference apparatus.

FIG. 4 is a diagram for describing an example of a system including the inference apparatus.

FIG. 5 is a diagram for describing Example 1.

FIG. 6 is a diagram for describing Example 2.

FIG. 7 is a diagram for describing Example 3.

FIG. 8 is a diagram for describing an example of the operations of the inference apparatus.

FIG. 9 is a diagram for describing an example of a computer that realizes the inference apparatus.

### EXAMPLE EMBODIMENT

First, an outline will be described for facilitating understanding of the example embodiments described below.

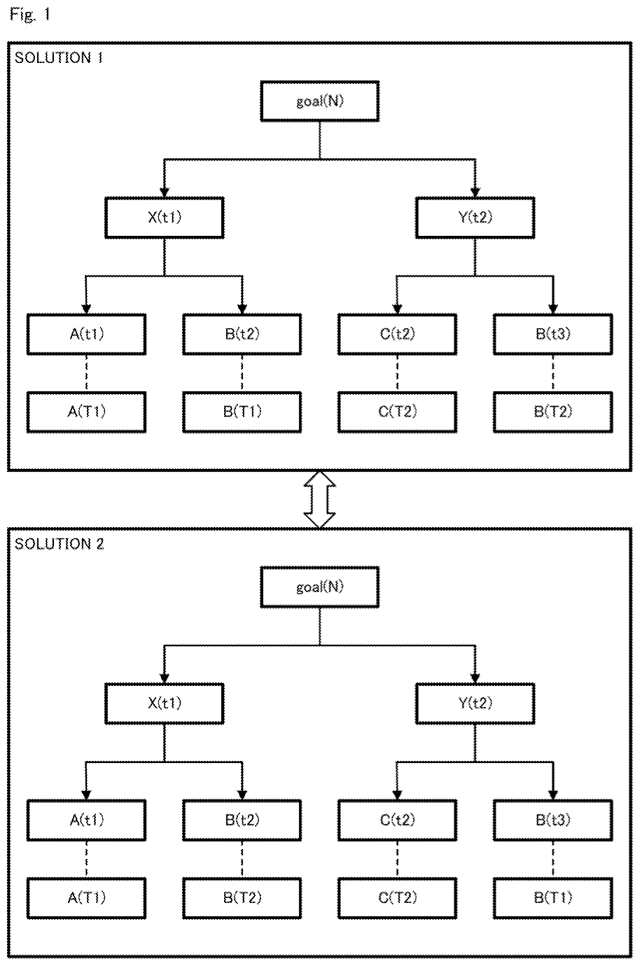

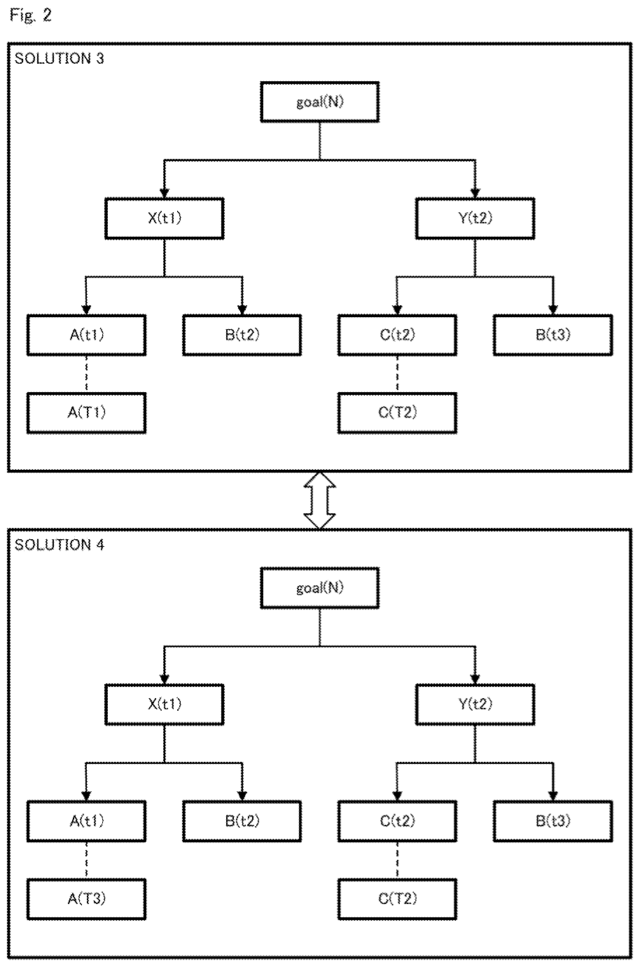

In the following example embodiments, cyber security is taken as an example, and the fact that a numerical relationship is difficult to be represented in weighted abduction will be described using FIGS. 1 and 2. FIGS. 1 and 2 are diagrams for describing weighted abduction and a numerical relationship.

Note that, in the example embodiments, a description will be given taking cyber security as an example, but the technique described in the example embodiments can also be applied to fields other than cyber security.

First, using FIG. 1, the fact will be described that, in weighted abduction, when a plurality of observation literals are unified, a combination of observation literals whose numerical values of their terms are close cannot be preferentially selected.

The example in FIG. 1 shows a result of performing weighted abduction using rules (logical formula set) as shown in Formula 1 and an evidence (observed event: conjunction of first-order predicate logic literals) as shown in Formula 2. The literals are atomic formulas or atomic formulas with a negation symbol. When the atomic formula is p(t1, t2, etc.), for example, p is a predicate symbol and t1, t2, etc. are terms. Note that, in the following, a term of a literal is a variable when starting with an alphabetical small letter, and is a constant when starting with a capital letter. The result in FIG. 1 indicates that a solution 1 and a solution 2, which achieve a minimum cost, has been derived.

A(t1)^{0.0}\hat{ }B(t2)^{0.0}=>X(t1)

C(t2)^{0.0}\hat{ }B(t3)^{0.0}\hat{ }=>Y(t2)

X(t1)^{0.0}\hat{ }Y(t2)^{0.0}=>goal(n) Formula 1
X, Y: Attack mean
A, B, C: Evidence
t1, t2: Time
Goal: Query indicating that there was some kind of attack
Superscript of literal: Weight

A(T1)¹⁰⁰\hat{ }B(T1)¹⁰⁰\hat{ }B(T2)¹⁰⁰\hat{ }C(T2)¹⁰⁰\hat{ }goal(N) Formula 2
T1, T2: Time
Superscript of literal: Cost

In the example in FIG. 1, first, hypothesis literals X(t1) and Y(t2) are derived from an observation literal Goal(N), which is a query indicating the start of deriving hypotheses by applying backward reasoning (arrows). Next, hypothesis literals A(t1) and B(t2) are derived from the hypothesis literal X(t1), and hypothesis literals C(t2) and B(t3) are derived from the hypothesis literal Y(t2). Note that, although not shown in FIG. 1, in backward reasoning, new hypotheses are derived using the rules and the observed event, and cost is propagated.

Next, in the example in FIG. 1, unification (broken lines) is performed. The solution 1 indicates that hypothesis literal A(t1) and the observation literal A(T1) are the same, the hypothesis literal B(t2) and the observation literal B(T1) are the same, the hypothesis literal C(t2) and the observation literal C(T2) are the same, and the hypothesis literal B(t3) and the observation literal B(T2) are the same. The solution 2 indicates that the hypothesis literal A(t1) and the observation literal A(T1) are the same, the hypothesis literal B(t2) and the observation literal B(T2) are the same, the hypothesis literal C(t2) and the observation literal C(T2) are the same, and the hypothesis literal B(t3) and the observation literal B(T1) are the same.

However, in the example in FIG. 1, the solution 1 and the solution 2 with which the cost is minimum are generated. The reason why the solution 1 and the solution 2 are generated is that, currently, evidences A, B, and C can only be regarded to be the same as one of evidences A, B, and C that are derived from an attack means X, or regarded to be the same as one of evidences A, B, and C that are derived from an attack means Y.

When the solution 1 and the solution 2 are compared, in the solution 1, the terms of the observation literal A(T1) and the observation literal B(T1) are both T1, and the terms of the observation literal C(T2) and the observation literal B(T2) are both T2, in contrast, in the solution 2, the terms of the observation literal A(T1) and the observation literal B(T2) are different, and the terms of the observation literal C(T2) and the observation literal B(T1) are also different. In such a case, a combination in which the times at which evidences have been observed are close is desired to be preferentially selected, that is, it is appropriate that the solution 1 in which the terms of the observation literals are the same is regarded as best.

Therefore, a method is conceivable for regarding the solution 1 as best using a logical formula. For example, rules as shown in Formula 3 are prepared. In Formula 3, A(t1) and B(t2) are requested as evidences of X(n), and furthermore a case where the values of the terms are the same (t1=t2) and a case where the values of the terms are different (t1!=t2) are also considered.

A(t1)\hat{ }B(t2)\hat{ }(t1=t2)=>X(n)

A(t1)\hat{ }B(t2)\hat{ }(t1!=t2)=>X(n) Formula 3
!: Negation

Also, weights are adjusted such that the evaluation by an evaluation function is improved when the rule in the first line in Formula 3 is used relative to when the rule in the second line in Formula 3 is used.

However, if the number of literals in antecedents of rules is increased, the number of rules explosively increases. For example, as a result of merely increasing the number of literals (A(t1), B(t2), and C(t3)) of antecedents to three, the number of rules is increased as shown in Formula 4, if sameness and difference of terms (t1, t2, t3) are considered.

A(t1)\hat{ }B(t2)\hat{ }C(t3)\hat{ }(t1=t2)\hat{ }(t2=t3)=>X(n)

A(t1)\hat{ }B(t2)\hat{ }C(t3)\hat{ }(t1!=t2)\hat{ }(t2=t3)=>X(n)

A(t1)\hat{ }B(t2)\hat{ }C(t3)\hat{ }(t1=t2)\hat{ }(t2!=t3)=>X(n)

A(t1)\hat{ }B(t2)\hat{ }C(t3)\hat{ }(t1=t3)\hat{ }(t2!=t3)=>X(n)

A(t1)\hat{ }B(t2)\hat{ }C(t3)\hat{ }(t1!=t2)\hat{ }(t2!=t3)\hat{ }(t3!=t1)=>X(n) Formula 4

Therefore, when the number of rules is increased, the search space for solution is expanded, and the inference calculation time increases. Also, when the number of rules is increased, the cost for maintaining the rules also increases.

Furthermore, as described above, when logical formulas are used, because logical formulas can only handle true or not, whether or not the terms are the same can only be handled. Therefore, a continuous numerical value indicating the closeness in time cannot be handled. As a result, when a plurality of observation literals are unified, a combination of observation literals in which the values of the terms thereof are close cannot be preferentially selected.

Next, the fact that attack means cannot be arranged in the order of first appearance with only using weighted abduction will be described using FIG. 2. In a cyber-attack, a plurality of attack means are used, and a same attack means is repeatedly executed, and therefore there is a need for understanding the degree of progress of the attack by arranging the attack means in the order of first appearance.

The example shown in FIG. 2 shows a result of performing weighted abduction, when attack means X and Y are executed in the order of X→Y→X, using rules as shown in Formula 1 and an evidence (observed event) as shown in Formula 5. In the example in FIG. 2, it is shown that a solution 3 and a solution 4, which achieve a minimum cost, are derived.

A(T1)¹⁰⁰\hat{ }B(T1)¹⁰⁰\hat{ }B(T2)¹⁰⁰\hat{ }C(T2)¹⁰⁰\hat{ }goal(N)1 Formula 5
T1<T2<T3
T1, T2, T3: Time

In the example in FIG. 2, first, backward reasoning (arrows) is applied, and hypothesis literals X(t1) and Y(t2) are derived from an observation literal Goal(N), which is a query. Next, the hypothesis literals A(t1) and B(t2) are derived from the hypothesis literal X(t1), and the hypothesis literals C(t2) and B(t3) are derived from the hypothesis literal Y(t2). Note that, although not shown in FIG. 2, in backward reasoning, new hypotheses are derived using the rules and the observed event, and cost is propagated.

Next, in the example in FIG. 2, a solution 3 and a solution 4 are obtained by performing unification (broken lines). The solution 3 indicates that the hypothesis literal A(t1) and the observation literal A(T1) are the same, and the hypothesis literal C(t2) and the observation literal C(T2) are the same. Also, the solution 4 indicates that the hypothesis literal A(t1) and the observation literal A(T3) are the same, and the hypothesis literal C(t2) and the observation literal C(T2) are the same.

However, the solution 3 and the solution 4 that achieve a minimum cost are generated. The reason why the solution 3 and the solution 4 are generated is because, in the example in FIG. 2, there are only a rule that the evidence A is observed at time t1 at which the attack means X has been executed, and a rule that the evidence C is observed at time t2 at which the attack means Y has been executed.

Moreover, it is because that the evidences A, B, and C, which are observed events, can only be regarded to be the same as one of evidences A, B, and C that are derived from the attack means X, or regarded to be the same as one of evidences A, B, and C that are derived from the attack means Y.

When the solution 3 and the solution 4 are compared, in the solution 3, the term of the observation literal A(T1) is T1 and the term of the observation literal C(T2) is T2, in contrast, in the solution 4, the term of the observation literal A(T3) is T3, and the term of the observation literal C(T2) is T2. In such a case, because the attack means X and Y are actually executed in the order of X→Y→X, it is appropriate that the solution 3 in which the attack means X and Y are arranged in the order of first appearance X→Y is regarded as best. Note that the solution 4 is not appropriate because the attack means X and Y are arranged in the order of Y→X.

Therefore, a method is conceivable for regarding the solution 3 as best using a logical formula. For example, a case where a sequence (time) of executing attack means is included in the rule is considered.

However, if the number of literals in antecedents of rules is increased, the number of rules explosively increases. For example, as a result of merely increasing the number of literals (A(t1), B(t2), C(t2), and B(t3)) of antecedents to four, if the sequence (temporal sequence) of t1, t2, and t3 is considered, the number of rules increases.

Also, if the temporal sequence is increased, the number of rules further increases. Therefore, when the number of rules is increased, the solution search space is expanded, and the inference calculation time increases. Also, when the number of rules is increased, the cost for maintaining the rules also increases.

Furthermore, as described above, when logical formulas are used, because logical formulas can only handle true or not, whether or not the terms are the same can only be handled. Therefore, the temporal sequence, which is a continuous numerical value, cannot be handled. As a result, when a plurality of observation literals are unified, the literals cannot be preferentially selected in the order of first appearance.

Through such a process, the inventor has found a problem that a numerical relationship cannot be reflected with only the weighted inference disclosed in Non-Patent Document 1 and the like. Also, the inventor has derived a means for solving the problem.

That is, the inventor has derived a means for, when a plurality of observation literals are unified, preferentially selecting a combination in which the values of the terms of observation literals are close, or a means for preferentially selecting a combination in which attack means are arranged in the order of first appearance. As a result, the numerical relationship can be reflected on abduction.

Hereinafter, the example embodiments will be described with reference to the drawings. Note that, in the drawings described below, the elements that have the same or corresponding functions are given the same reference numerals and description thereof may not be repeated.

### Example Embodiment

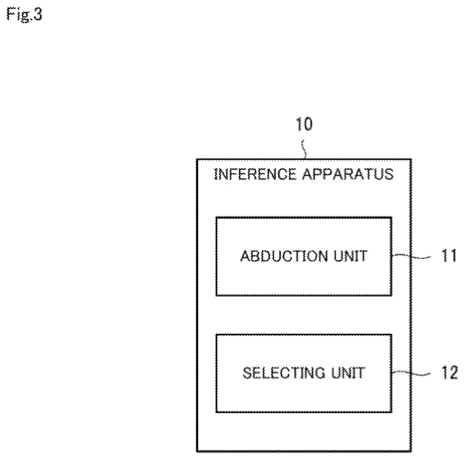

The configuration of an inference apparatus according to the example embodiment will be described using FIG. 3. FIG. 3 is a diagram for describing an example of the inference apparatus.

### [Apparatus Configuration]

An inference apparatus 10 shown in FIG. 3 is an apparatus that executes inference. Also, as shown in FIG. 3, the inference apparatus 10 includes an abduction unit 11 and a selecting unit 12.

Among these units, the abduction unit 11 executes abduction by applying inference knowledge including a plurality of rules that are represented by logical formulas to observation logical formulas that are obtained by representing observed facts using logical formulas, and outputs a plurality of solution hypotheses whose costs are the same. The selecting unit 12 evaluates each of the solution hypotheses based on an evaluation criterion, and selects a solution hypothesis based on the evaluation results.

In the example embodiment, as a result of using the abduction unit 11 and the selecting unit 12, as described above, a numerical relationship can be reflected on the abduction.

### [System Configuration]

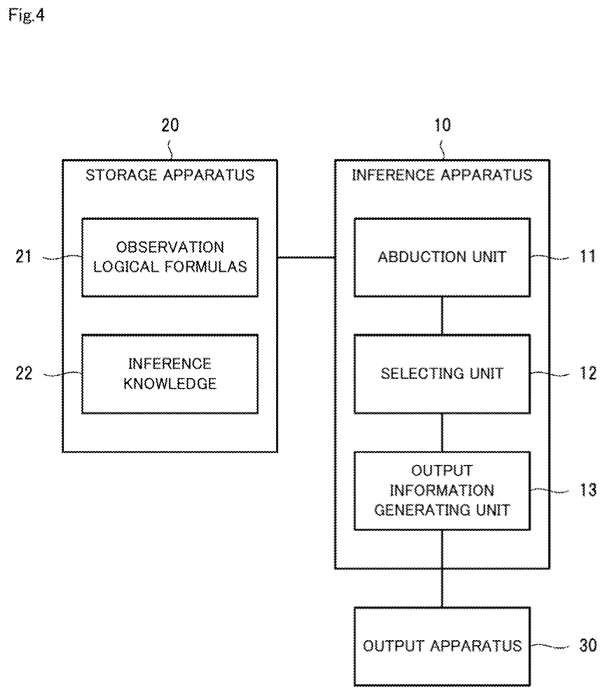

The configuration of the inference apparatus 10 in the example embodiment will be more specifically described using FIG. 4. FIG. 4 is a diagram for describing an example of a system including the inference apparatus.

As shown in FIG. 4, the system in the example embodiment includes the inference apparatus 10, a storage apparatus 20, and an output apparatus 30. The inference apparatus 10, the storage apparatus 20, and the output apparatus 30 are connected via a network.

The inference apparatus 10 includes the abduction unit 11, the selecting unit 12, and an output information generating unit 13. The inference apparatus 10 is an information processing apparatus such as a server computer or a personal computer on which a programmable device such as a CPU (Central Processing Unit) or an FPGA (Field-Programmable Gate Array) or both of the programmable devices are mounted, for example. Note that the details of the inference apparatus 10 will be described later.

The storage apparatus 20 includes observation logical formulas 21 and inference knowledge 22. The storage apparatus 20 is a database or a storage, a server computer, or the like. The observation logical formulas 21 are obtained by representing observed facts by logical formulas (conjunctions of first-order predicate logic literals). The inference knowledge 22 includes a plurality of rules (logical formula set) represented by logical formulas.

The storage apparatus 20 is provided outside the inference apparatus 10 in the example in FIG. 4, but may be provided inside the inference apparatus 10. Also, one storage apparatus 20 is shown in the example in FIG. 4, but the storage apparatus 20 may also be constituted by a plurality of storage apparatuses. In this case, the observation logical formulas 21 and the inference knowledge 22 may also be stored in a distributed manner.

The output apparatus 30 acquires later-described output information that is converted, by the output information generating unit 13, into a format that can be output, and outputs images, audio and the like generated based on this output information. The output apparatus 30 is an image display apparatus that uses liquid crystal, organic EL (ElectroLuminescence) or a CRT (Cathode Ray Tube). Furthermore, the image display apparatus may include an audio output apparatus such as a speaker, and the like. Note that the output apparatus 30 may also be a printing device such as a printer.

The inference apparatus will be described.

The abduction unit 11 executes weighted abduction by, specifically, applying the inference knowledge 22 stored in the storage apparatus 20 shown in FIG. 4 to the observation logical formulas 21 stored in the storage apparatus 20 shown in FIG. 4, and outputs a plurality of solution hypotheses (same point solutions) with the same cost. As a result of the abduction unit 11 outputting all of the same cost solutions with the same cost, in this way, all possible combinations of the observation literals can be encompassed.

When a plurality of solution hypotheses (same point solutions) are output, the selecting unit 12, specifically, evaluates each of the solution hypotheses that have been output using an evaluation function that expresses a numerical relationship. Subsequently, the selecting unit 12 selects, by comparing the evaluation results with a preset condition, a solution hypothesis corresponding to an evaluation result that matches the condition. For example, when the condition is a minimum value, the selecting unit 12 selects a solution hypothesis for which the evaluation result is a minimum value, by referring to evaluation results (values) of the plurality of same point solutions.

The output information generating unit 13 generates output information for causing the output apparatus 30 to output the result of abduction, the evaluation function, an evaluation result for each solution hypothesis, and the like, and output the output information to the output apparatus 30.

### Example 1

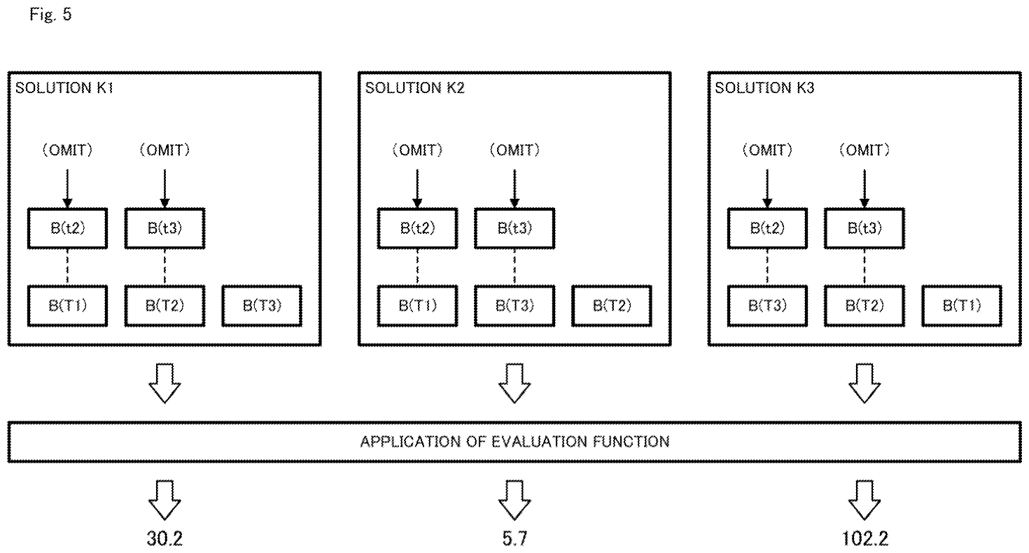

FIG. 5 is a diagram for describing Example 1. An example in which the abduction unit 11 outputs a solution K1, a solution K2, and a solution K3, as solution hypotheses, is shown in FIG. 5. Particularly, combinations of observation literals B(T1), B(T2), and B(T3) that can be unified with hypothesis literals B(t2) and B(t3) are output as solution hypotheses, namely a solution K1, a solution K2, and a solution K3. Note that the observation literals B(T1), B(T2), and B(T3) have the same cost.

Also, FIG. 5 illustrates that the selecting unit 12 has calculated an evaluation function with respect to each of the solution K1, the solution K2, and the solution K3. FIG. 5 illustrates that the evaluation result of the solution K1 is 30.2, the evaluation result of the solution K2 is 5.7, and the evaluation result of the solution K3 is 102.2, as evaluation results calculated using the evaluation function.

If the condition is a minimum value, because the evaluation result of the solution K2 is minimum in FIG. 5, the selecting unit 12 selects the solution K2 as a desirable solution.

### Example 2

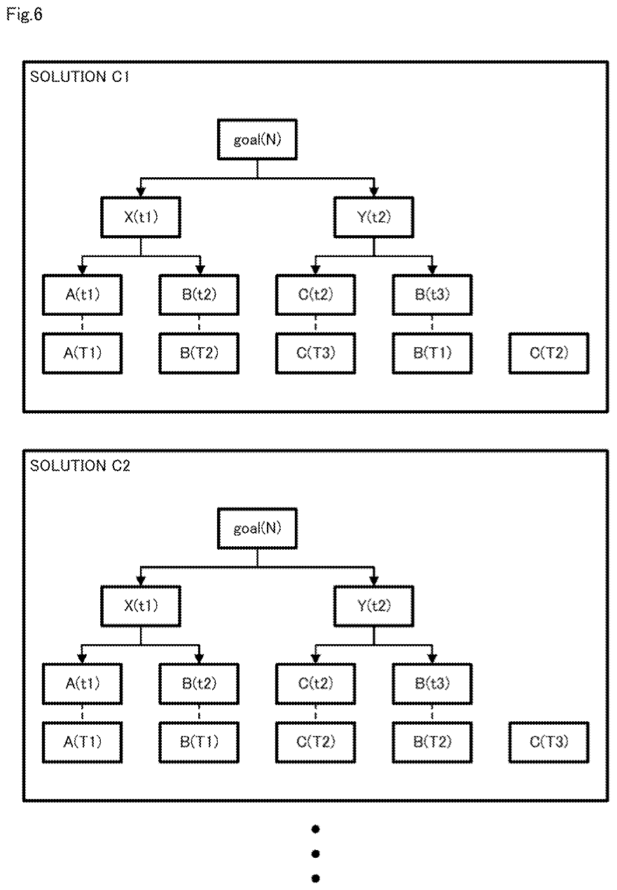

FIG. 6 is a diagram for describing Example 2. In Example 2, with respect to evidences A and B related to an attack means X and evidences C and B related to an attack means Y, hypotheses in which closeness in time is achieved are obtained.

In Example 2, the abduction unit 11 executes weighted abduction using rules as shown in Formula 6 and an evidence (observed event) as shown in Formula 7. Assume that, as a result, a plurality of solutions, namely a solution C1, a solution C2, etc., are obtained as shown in FIG. 6.

A(t1)^{0.0}\hat{ }B(t2)^{0.0}=>X(t1)

C(t2)^{0.0}\hat{ }B(t3)^{0.0}=>Y(t2)

X(t1)^{0.0}\hat{ }Y(t2)^{0.0}=>goal(n) Formula 6

A(T1)¹⁰⁰\hat{ }B(T1)¹⁰⁰\hat{ }B(T2)¹⁰⁰\hat{ }C(T2)¹⁰⁰\hat{ }C(T3)¹⁰⁰\hat{ }goal(N)¹ Formula 7
T1<T2<T3

Next, the selecting unit 12 calculates an evaluation result using an evaluation function for each of a plurality of solutions, namely a solution C1, a solution C2, etc., and selects a solution regarding which the evaluation result matches a condition.

Regarding the evaluation function, when a hypothesis in which closeness in time is achieved is to be obtained, for example, evaluation is performed using an evaluation function such as evaluation result R=(closeness in time between evidences A and B related to X)+(closeness in time between evidences B and C related to Y). In the example in FIG. 6, evaluation results R (R1, R2, etc.) as shown in Formula 8 are obtained.

$$R 1 = {( T 1 - T 2 )}^{2} + {( T 3 - T 1 )}^{2} > 0 \qquad Formula 8$$

$$R 2 = {( T 1 - T 1 )}^{2} + {( T 2 - T 2 )}^{2} = 0$$

$$…$$

Next, the selecting unit 12 selects an evaluation value that matches a preset condition from the evaluation results (evaluation values: R1, R2, etc.). For example, when the condition is a minimum value, the selecting unit 12 selects the solution C2 corresponding to the evaluation value R2.

According to Example 2, with respect to evidences A and B related to the attack means X and evidences C and B related to the attack means Y, a hypothesis in which closeness in time is achieved for each of the pairs of the evidences can be obtained.

### Example 3

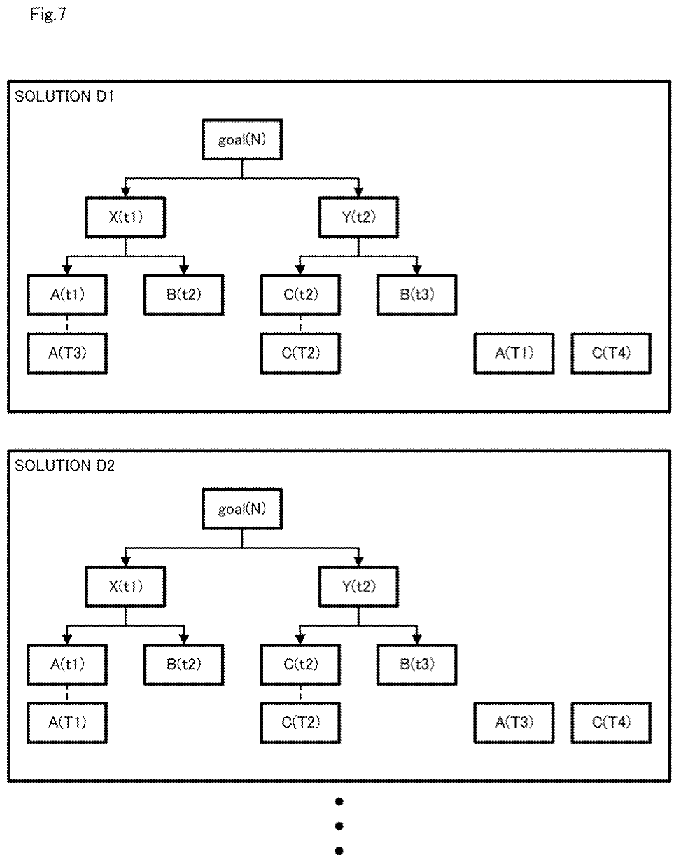

FIG. 7 is a diagram for describing Example 3. In the Example 3, a hypothesis in which attack means X and Y are in the order of first appearance is obtained.

In Example 3, the abduction unit 11 executes weighted abduction using rules as shown in Formula 9 and an evidence (observed event) as shown in Formula 10. Assume that, as a result, a plurality of solutions, namely a solution D1, a solution D2, etc., are obtained as shown in FIG. 7.

A(t1)^{0.0}\hat{ }B(t2)^{0.0}=>X(t1)

C(t2)^{0.0}\hat{ }B(t3)^{0.0}\hat{ }=>Y(t2)

X(t1)^{0.0}\hat{ }Y(t2)^{0.0}=>goal(n) Formula 9

A(T1)¹⁰⁰\hat{ }A(T3)¹⁰⁰\hat{ }C(T2)¹⁰⁰\hat{ }C(T4)¹⁰⁰\hat{ }goal(N)¹ Formula 10
T1<T2<T3<T4

The selecting unit 12 obtains an evaluation result using an evaluation function for each of a plurality of solutions, namely the solution D1, the solution D2, etc., and selects a solution regarding which the evaluation result matches a condition.

Regarding the evaluation function, when a hypothesis in which closeness in time is achieved is to be obtained, for example, evaluation is performed using an evaluation function such as evaluation result R=(time of X portion)+(time of Y portion). In the example in FIG. 7, evaluation results R (R1, R2, etc.) as shown in Formula 11 are obtained.

$$R 1 = ( T 3 ) + ( T 2 ) \qquad Formula 11$$

$$R 2 = ( T 1 ) + ( T 2 )$$

$$…$$

Next, the selecting unit 12 selects an evaluation value that matches a preset condition from the evaluation results (evaluation values: R1, R2, etc.). For example, when the condition is a minimum value, the selecting unit 12 selects the solution D2 corresponding to the evaluation value R2.

According to the Example 3, a hypothesis in which attack means X and Y are in the order of first appearance is obtained.

### [Apparatus Operations]

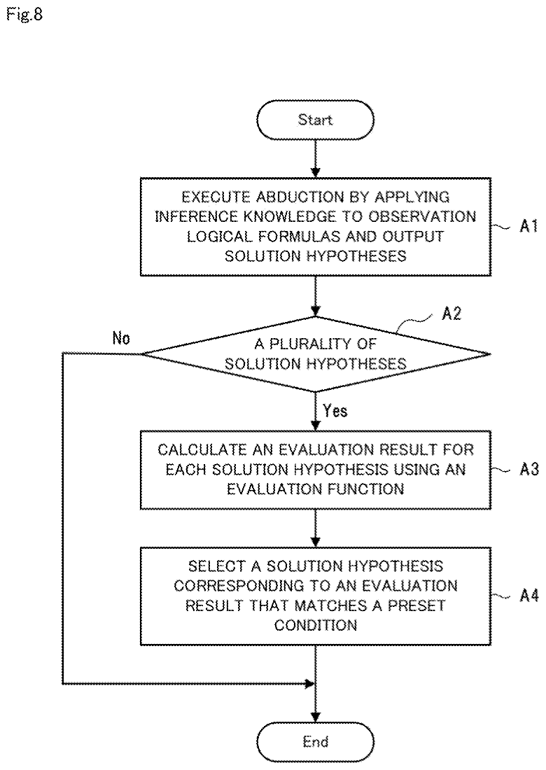

Next, operations of the inference apparatus in the example embodiment will be described using FIG. 8. FIG. 8 is a diagram illustrating an example of the operations of the inference apparatus. In the following description, the drawings will be referred to as appropriate. Furthermore, in the example embodiment, an inference method is implemented by causing the inference apparatus to operate. Accordingly, the following description of the operations of the inference apparatus is substituted for the description of the inference method in the example embodiment.

As shown in FIG. 8, first, the abduction unit 11 executes abduction by applying inference knowledge including a plurality of rules that are represented by logical formulas to observation logical formulas that are obtained by representing observed facts using logical formulas, and outputs a plurality of solution hypotheses whose costs are the same (step A1).

Specifically, in step A1, the abduction unit 11 executes weighted abduction by applying inference knowledge stored in the storage apparatus 20 shown in FIG. 4 to observation logical formulas stored in the storage apparatus 20 shown in FIG. 4, and outputs a plurality of solution hypotheses whose costs are the same (same point solutions). As a result of the abduction unit 11 outputting all of the same point solutions with the same cost, in this way, all possible combinations of the observation literals can be encompassed.

Next, the selecting unit 12 determines whether or not a plurality of solution hypotheses have been output (step A2). If a plurality of solution hypotheses have been output (step A2: Yes), the selecting unit 12 calculates an evaluation result for each solution hypothesis using an evaluation function (step A3). If the number of solution hypotheses is one (step A2: No), the selecting unit 12 determines this solution hypothesis as a desired solution.

When a plurality of solution hypotheses (same point solutions) have been output, the selecting unit 12 evaluates each of the solution hypotheses that have been output using an evaluation function that expresses a numerical relationship, and selects a solution hypothesis corresponding to an evaluation result that matches a preset condition (step A4). For example, if the condition is a minimum value, the selecting unit 12 refers to the evaluation results (values) of the plurality of respective same point solutions, and selects a solution hypothesis corresponding to an evaluation result having a minimum value.

### [Effects of Embodiment]

As described above, according to the example embodiment, a numerical relationship can be reflected on abduction, while retaining logical consistency, using a result obtained by the abduction.

Also, the number of rules is not increased, and the solution search space is not expanded, and therefore the inference calculation time can be suppressed compared with the case where the number of rules is increased. Also, in general, maintenance needs to be performed such that created rules are not in contradiction with each other, but since the number of rules is not increased, the rule maintenance cost can also be suppressed.

Also, the numerical relationship is evaluated after performing abduction, and therefore the evaluation function for the numerical relationship can be freely designed without receiving constraints of logical inference.

### [Program]

The program according to an embodiment may be a program that causes a computer to execute steps A1 to A4 shown in FIG. 8. By installing this program in a computer and executing the program, the inference apparatus and the inference method according to the example embodiment can be realized. In this case, the processor of the computer performs processing to function as the abduction unit 11, the selecting unit 12, and the output information generating unit 13.

Also, the program according to the embodiment may be executed by a computer system constructed by a plurality of computers. In this case, for example, each computer may function as any of the abduction unit 11, the selecting unit 12, and the output information generating unit 13.

### [Physical Configuration]

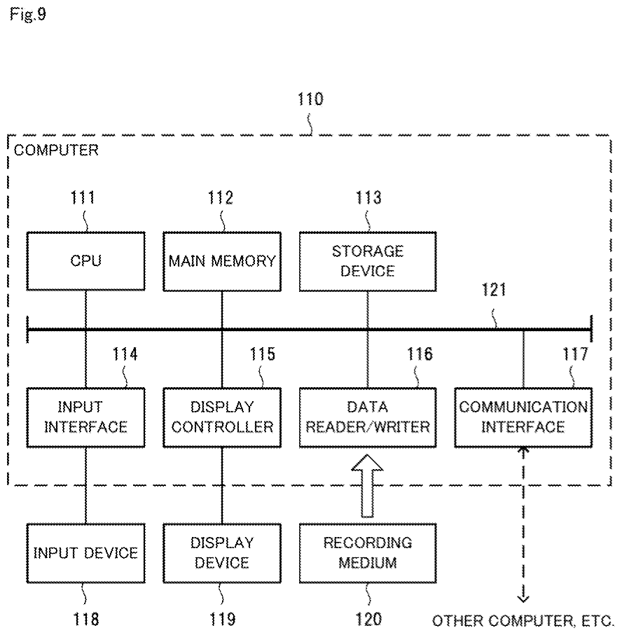

Here, a computer that realizes an inference apparatus by executing the program according to an example embodiment will be described with reference to FIG. 9. FIG. 9 is a diagram for describing an example of a computer that realizes the inference apparatus.

As shown in FIG. 9, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the event analysis support apparatus 1 according to this example embodiment can also be realized by using hardware corresponding to each unit. Furthermore, a portion of the event analysis support apparatus 1 may be realized by a program, and the remaining portion realized by hardware.

### [Supplementary Notes]

Furthermore, the following supplementary notes are disclosed regarding the example embodiments described above. Some portion or all of the example embodiments described above can be realized according to (supplementary note 1) to (supplementary note 9) described below, but the below description does not limit the invention.

### (Supplementary Note 1)

An inference apparatus comprising:

an abduction unit that executes abduction by applying inference knowledge including a plurality of rules that are represented by logical formulas to an observation logical formula obtained by representing an observed fact using a logical formula, and outputting a plurality of solution hypotheses whose costs are the same; and

a selection unit that selects, by evaluating each of the solution hypotheses based on an evaluation criterion, a solution hypothesis according to evaluation results.

### (Supplementary Note 2)

The inference apparatus according to Supplementary Note 1,

wherein the selection unit evaluates each of the solution hypotheses using an evaluation function expressing a numerical relationship, and selects a solution hypothesis for which the evaluation result matches a preset condition.

### (Supplementary Note 3)

The inference apparatus according to Supplementary Note 2,

wherein the selection unit evaluates terms of observation literals related to a same hypothesis literal using the evaluation function, and selects a solution hypothesis that matches the condition.

### (Supplementary Note 4)

An inference method comprising:

an abduction step of executing abduction by applying inference knowledge including a plurality of rules that are represented by logical formulas to an observation logical formula obtained by representing an observed fact using a logical formula, and outputting a plurality of solution hypotheses whose costs are the same; and

a selection step of selecting, by evaluating each of the solution hypotheses based on an evaluation criterion, a solution hypothesis based on evaluation results.

### (Supplementary Note 5)

The inference method according to Supplementary Note 4,

wherein, in the selection step, each of the solution hypotheses are evaluated using an evaluation function expressing a numerical relationship, and a solution hypothesis for which the evaluation result matches a preset condition is selected.

### (Supplementary Note 6)

The inference method according to Supplementary Note 5,

wherein, in the selection step, terms of observation literals related to a same hypothesis literal are evaluated using the evaluation function, and a solution hypothesis that matches the condition is selected.

### (Supplementary Note 7)

A computer-readable recording medium that includes a program including instructions recorded thereon, the instructions causing a computer to carry out:

an abduction step of executing abduction by applying inference knowledge including a plurality of rules that are represented by logical formulas to an observation logical formula obtained by representing an observed fact using a logical formula, and outputting a plurality of solution hypotheses whose costs are the same; and

a selection step of selecting, by evaluating each of the solution hypotheses based on an evaluation criterion, a solution hypothesis based on evaluation results.

### (Supplementary Note 8)

The computer-readable recording medium according to Supplementary Note 7,

wherein, in the selection step, each of the solution hypotheses are evaluated using an evaluation function expressing a numerical relationship, and a solution hypothesis for which the evaluation result matches a preset condition is selected.

### (Supplementary Note 9)

The computer-readable recording medium according to Supplementary Note 8,

wherein, in the selection, terms of observation literals related to a same hypothesis literal are evaluated using the evaluation function, and a solution hypothesis that matches the condition is selected.

Although the invention of this application has been described with reference to exemplary embodiments, the invention of this application is not limited to the above exemplary embodiments.

Within the scope of the invention of this application, various changes that can be understood by those skilled in the art can be made to the configuration and details of the invention of this application.

### INDUSTRIAL APPLICABILITY

As described above, according to the invention, it is possible to reflect numerical relationships on abduction. The invention is useful in fields where it is necessary to abduction.

### REFERENCE SIGNS LIST

10 Inference apparatus
11 Abduction unit
12 Selecting unit
13 Output information generating unit
20 Storage apparatus
21 Observation logical formula
22 Inference knowledge
30 Output apparatus
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An inference apparatus comprising:
at least one memory configured to store instructions; and
at least one processor configured to execute the instructions to:
execute abduction by applying inference knowledge including a plurality of rules that are represented by logical formulas to an observation logical formula obtained by representing an observed fact using a logical formula, and outputting a plurality of solution hypotheses whose costs are the same; and
select, by evaluating each of the solution hypotheses based on an evaluation criterion, a solution hypothesis according to evaluation results.

2. The inference apparatus according to claim 1,
wherein the one or more processors is further configured to execute the instructions to, evaluate each of the solution hypotheses using an evaluation function expressing a numerical relationship, and select a solution hypothesis for which the evaluation result matches a preset condition.

3. The inference apparatus according to claim 2,
wherein one or more processors is further configured to execute the instructions to, evaluate terms of observation literals related to a same hypothesis literal using the evaluation function, and select a solution hypothesis that matches the condition.

4. An inference method comprising:
executing abduction by applying inference knowledge including a plurality of rules that are represented by logical formulas to an observation logical formula obtained by representing an observed fact using a logical formula, and outputting a plurality of solution hypotheses whose costs are the same; and
selecting, by evaluating each of the solution hypotheses based on an evaluation criterion, a solution hypothesis based on evaluation results.

5. The inference method according to claim 4,
wherein, in the selecting, each of the solution hypotheses are evaluated using an evaluation function expressing a numerical relationship, and a solution hypothesis for which the evaluation result matches a preset condition is selected.

6. The inference method according to claim 5,
wherein, in the selecting, terms of observation literals related to a same hypothesis literal are evaluated using the evaluation function, and a solution hypothesis that matches the condition is selected.

7. A non-transitory computer-readable recording medium that includes a program including instructions recorded thereon, the instructions causing a computer to carry out:
executing abduction by applying inference knowledge including a plurality of rules that are represented by logical formulas to an observation logical formula obtained by representing an observed fact using a logical formula, and outputting a plurality of solution hypotheses whose costs are the same; and
selecting, by evaluating each of the solution hypotheses based on an evaluation criterion, a solution hypothesis based on evaluation results.

8. The non-transitory computer-readable recording medium according to claim 7,
wherein, in the selecting, each of the solution hypotheses are evaluated using an evaluation function expressing a numerical relationship, and a solution hypothesis for which the evaluation result matches a preset condition is selected.

9. The non-transitory computer-readable recording medium according to claim 8,
wherein, in the selecting, terms of observation literals related to a same hypothesis literal are evaluated using the evaluation function, and a solution hypothesis that matches the condition is selected.
